(19) United States
(12) Patent Application Publication
(10) Pub. No.: US 2008/0164772 A1
(43) Pub. Date: Jul. 10, 2008

(54) Machine for operation of electric generators and/or other machines (The Cleveland Engine)

(75) Inventor: Cleve Lawrence Molette, East Point, GA (US)

Correspondence Address: CLEVE LAWRENCE MOLETTE, 3340 DESERT CIR., # 38, EAST POINT, GA, 30344, US

(73) Assignee: Cleve Lawrence Molette, East Point, GA (US)

(21) Appl. No.: 11/620,116

(22) Filed: Jan. 5, 2007

(51) Int. Cl. H02K 16/00; H02K 37/10; H02K 7/116; H02K 7/10

(52) U.S. Cl. 310/46; 310/114; 310/83; 310/79

(57) ABSTRACT

Using this invention, no input fuel is required to sustain operation of electric generators and other machines and devices. This is done using a magnetic motor that has parallel and perpendicular, rotatable shafts and gears to which those generators and other machines are connected along with equally spaced, perpendicular extensions having permanent magnets attached to those extensions and arranged so as to allow repelling magnetic interaction; and where the shafts also have ways of maintaining required spacing and rotational timing to allow the magnets to interact in precise and extremely close proximity a number of times per rotation causing perpetual movement.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of motors and more specifically to a machine for operation of electrical generators and/or other mechanical machines (The Cleveland Engine). During my patent search, I found an insane number of patented magnetic motors which, to me, serves as testimony to our ever present search for a reliable way to produce the electrical and mechanical power required of our modern lifestyles. Magnetic motors use either the repelling or attracting forces of magnets to cause rotational or linear forces (usually to a shaft of some sort), which are then applied in some manner to the operation of electrical generators or other machines that require mechanical power to function. Prior technologies in this field appear to follow two basic concepts. The first of these two concepts is the use of a stator (stationary motor part) and a rotor (rotary motor part) where one part will contain permanent magnets and the other part electromagnets which must receive an externally generated electric pulse at a precise moment (usually employing sensors) as illustrated in U.S. Pat. No. 6,954,019 (FIG. 7), U.S. Pat. No. 7,075,200 (FIG. 8), and U.S. Pat. No. 7,148,596 (FIG. 9). The other general concept is to use permanent magnets on both stator and rotor much in the same way as shown in U.S. Pat. No. 6,433,452 (FIG. 10) had it been designed as such without its sliding linear arm. The limitations of the two concepts above are apparent.

The primary limitations of the first concept are that it requires input energy in order to function properly, electromagnets which add to manufacturing costs, and it requires expensive sensors as a means to time and send an electric pulse from the external source at the precise moment in order to create the magnetic field required to perform work. On the other hand, the “death nail” for using permanent magnets on both stator and rotor is the resistance against continual motion of the rotor magnets caused by the repelling or attracting forces of the stator magnets on one or both sides of said rotor magnets.

This is where my invention proves new, novel, and useful. By utilizing a plurality of rotors (versus a rotor and stator), with magnets attached to perpendicular extensions from the rotor shafts, and gears affixed to the shafts, all of the limitations above are eliminated. The rotors are supported in a manner as to allow interaction between the magnets (no outside electrical pulse is required to perform work). The gears are set on the shafts so as to bring the magnets in extremely close proximity with each full rotation (thereby replacing the need for expensive sensors). Furthermore, there is zero magnetic resistance to continual shaft rotation as would be realized in the concept of using permanent magnets on both rotor and stator.

### BRIEF SUMMARY OF THE INVENTION

The primary object of the invention is that it is completely environmentally friendly—produces no toxic or hazardous waste and pollution.

Another object of the invention is it requires no input energy like gas, diesel, coal, solar, water, wind, waves, etc. . . .

Another object of the invention is it can create both electrical and mechanical output energy.

Yet another object of the invention is it continually produces work for the life of the propelling magnets, 20 or more years.

Still yet another object of the invention is its operation can be halted without total disassembly.

Another object of the invention is it can be configured to power all future electric vehicles, vessels, machinery, etc. . . .

Another object of the invention is can be developed for use in both domestic and industrial applications.

A further object of the invention is can be configured to operate a plurality of electrical generators.

Yet another object of the invention is inexpensive to manufacture, Simple to assemble, Easy to operate.

Other objects and advantages of the present invention will become apparent from the following descriptions, taken in connection with the accompanying drawings, wherein, by way of illustration and example, an embodiment of the present invention is disclosed.

Every home, vehicle, boat, machine, aircraft, spacecraft, company, and/or any other thing that requires electrical and/or mechanical energy will be subject to this invention in the future. I can't think of anything more prudent than owning a machine that actually produces energy at NO COST—the “money tree” of machines—The Cleveland Engine.

This invention is a magnetic motor comprising a number of equally spaced, perpendicular extensions having a number of permanent magnets attached to said extensions which are affixed to a plurality of rotatable shafts wherein said shafts are supported in a manner such as to allow said shafts to rotate and/or slide and allow magnets to interact with said magnets of other shafts; and where said shafts comprise a means of maintaining required rotational timing and magnet proximity to ensure maximum or desired repelling, rotational force from magnetic interaction with each rotation causing perpetual motion; and where no electromagnets, internal combustion engines, solar power, etc are employed, making said magnetic motor independent of outside energy requirements; and where said magnetic motor may be configured to employ a plurality of beveled gears to allow for an unspecified number of output shafts.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 depicts a top view of the magnetic motor without the motor frame according to this invention;

FIG. 2 depicts a front view of the magnetic motor without the motor frame according to this invention;

FIG. 3 depicts a top view of the magnetic motor with the motor frame according to this invention;

FIG. 4 depicts a front view of the magnetic motor with the motor frame according to this invention;

FIG. 5 depicts a top view of the magnetic motor with frame sleeves fully extended according to this invention;

FIG. 6 depicts one of a plurality of possible embodiments of the magnet motor according to this invention;

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

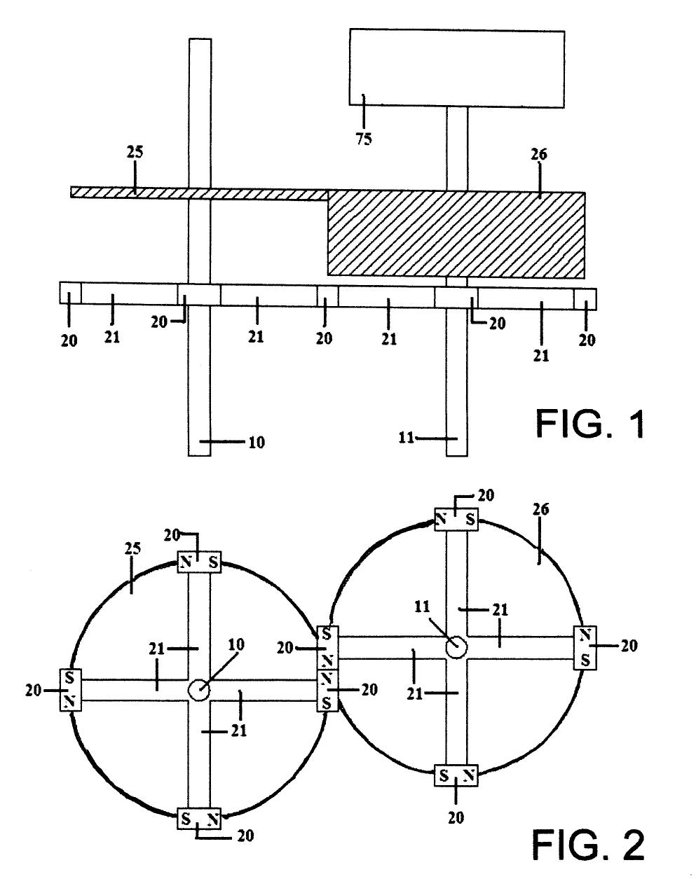

It is already well known that when the same “poles” of two magnets interact, they cause a repelling force one on the other. As shown in FIGS. 1 and 2, this embodiment of The Cleveland Engine comprises a number of parallel, rotatable shafts 10, 11 where thereon are affixed a number of equally spaced, perpendicular extensions 21. Said extensions 21 comprise a number of permanent magnets 20 affixed thereon and arranged so as to allow repelling magnetic interaction as the magnets 20 pass a center point between the shafts 10, 11 per rotation of said magnets 20. The rotatable shafts 10, 11 are the motor's rotors. The motor has no stator members. The shafts 10, 11 in this embodiment also comprise a number of gears of differing lengths 25, 26 to maintain rotational timing. Said gears 25, 26 are aligned to ensure said magnets are interacting in extremely close proximity a number of times per rotation causing perpetual movement. Therefore, an electric generator and/or other machine requiring rotational force in order to function 75 can be connected to this invention's output shaft 11 to receive said force. FIGS. 1 and 2 were intentionally displayed without the M-shaped base frame 40 to give a more clear view of internal parts.

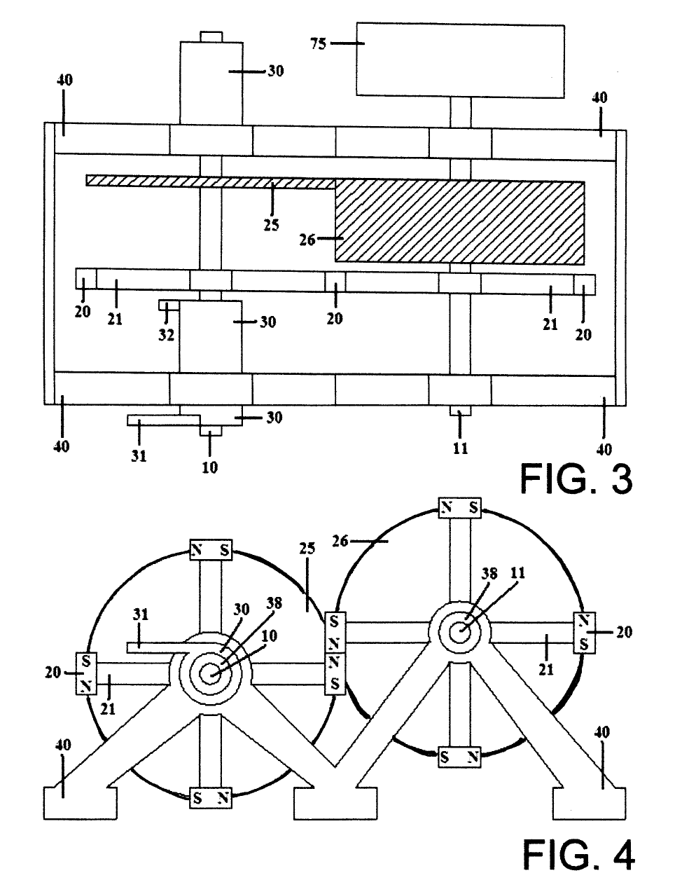

FIGS. 3 and 4 shows said embodiment above using an M-shaped base frame 40 whereas the sections of said M-shaped base frame 40 are identical on each end of said shafts 10, 11 whereas sections of said M-shaped base frame 40 contain identical measurements and parts disposed therein with the exception of pull handle 31 and stop pin 32 being located only on sleeve 30 supporting the front end of shaft 10. Inside said M-shaped base frame 40 are two slidably disposed sleeves 30 and four bearings 38 which, in this embodiment, the four bearings 38 act as a means to allow rotation of said shafts 10, 11 and where the sleeves 30 act as a means to allow only shaft 10 to slide to different positions within said M-shaped base frame 40. Used together, the M-shaped base frame 40, the sleeves 30, and the bearings 38 are the means by which rotatable shafts 10, 11 are supported in a manner such as to maintain required spacing and allow gears 25, 26 and magnets 20 interaction between said shafts when interaction is intended.

The opposing surfaces of said magnets 20 of a rotary shaft 10 interact with opposing surfaces of magnets 20 of another shaft 11 at a point in between the shafts 10, 11 which causes movement of said extensions 21 to which magnets 20 are affixed. Movement of said extensions 21 transforms repelling magnetic interaction into a rotational movement of shafts 10, 11. Rotational movement of shaft 10, 11 then causes rotation of gears 25, 26 thereon firmly affixed. The gears 25, 26 in turn ensure that the rotation of shafts 10, 11, extensions 21, and magnets 20 occur with precision so as to ensure maximum force can be achieved from the opposing surfaces of repelling magnets 20. Connected beforehand to the output shaft 11 of this motor, an electric generator and/or other machine requiring mechanical torque for operation 75 can be operated without consideration for need of outside electric pulses, fuel, etc. of any kind.

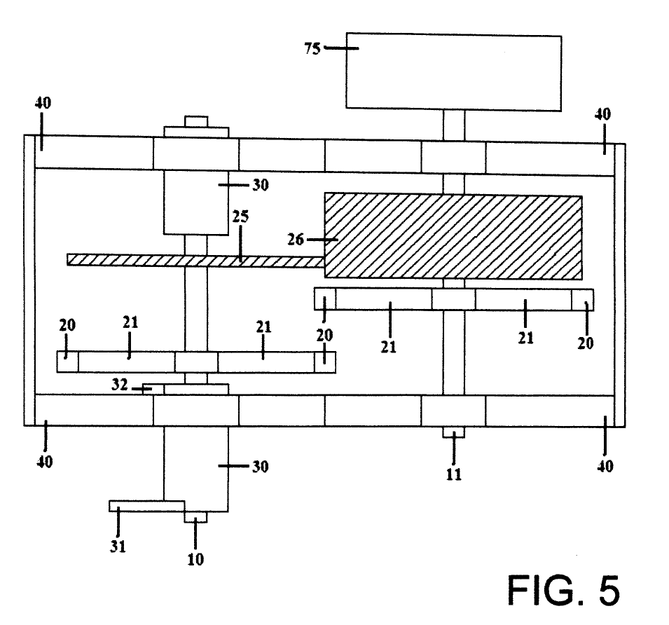

Now, please turn your attention to FIG. 5, which depicts use of said sleeves 30 to slide shaft 10, its extensions 21, and its magnets 20 into differing positions using pull handle 31. Stop pin 32 prevents sleeve 30 from being pulled completely out of the M-shaped frame 40. It is also noteworthy here that gears 25, 26 are of differing lengths which allows this motor to maintain prescribed precise rotational timing of said magnets 20 as shaft 10 and its gear 25, extensions 21, and magnets 20 are being repositioned or also while said shaft 10 is at rest in differing positions. The bearings 38 contained on all four ends of the shafts 10, 11 allow continued rotation even as shaft 10 is being repositioned. Therefore, sleeves 30, bearings 38, and gears 25, 26 act as the means by which shaft 10 can rotate while sliding or while at rest in differing positions. Drawing the pull handle 31 away from the M-shaped frame 40 decreases the proximity of magnets 20 and thereby causes a decrease in the amount of repulsive force between said magnets 20 as they continue to spin or a cessation of force altogether. Consequently, pushing the handle 31 towards the M-shaped base frame 40 increases the proximity of magnets 20 and in so doing causes the start of shafts 10, 11 rotation or an increase thereof. This is advantageous because it allows control of the engines output and/or allows for output stoppage so that routine maintenance of parts can be achieved.

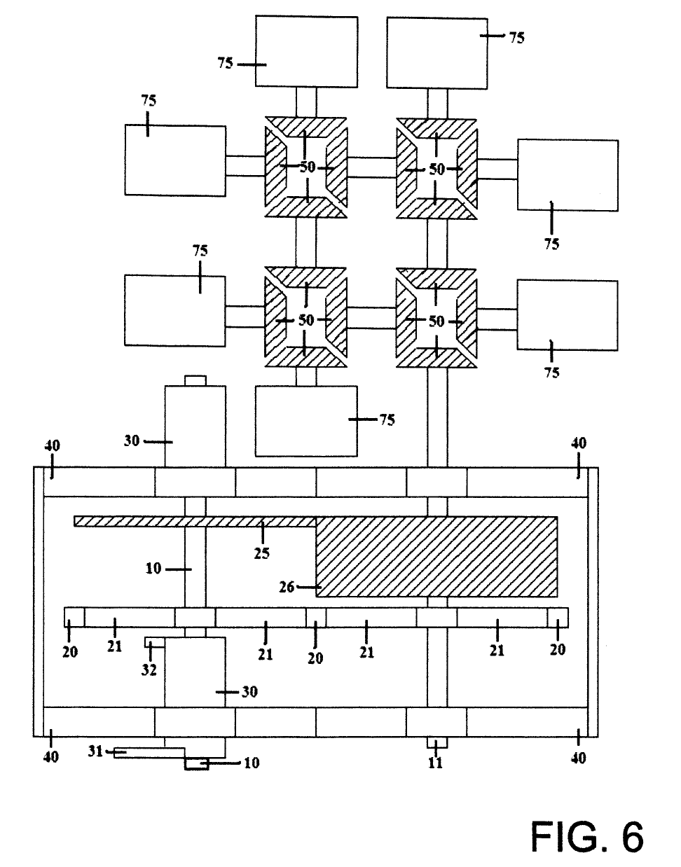

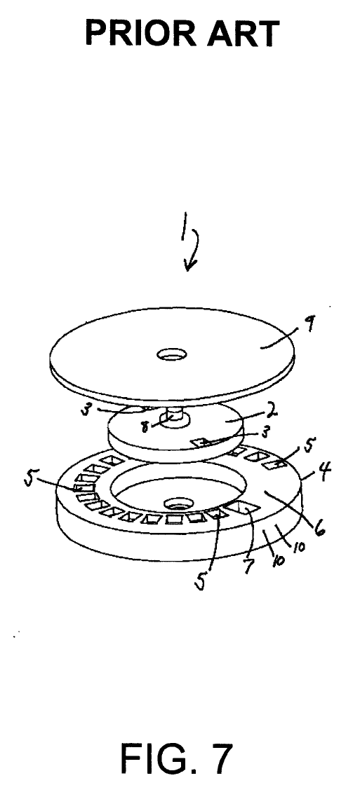

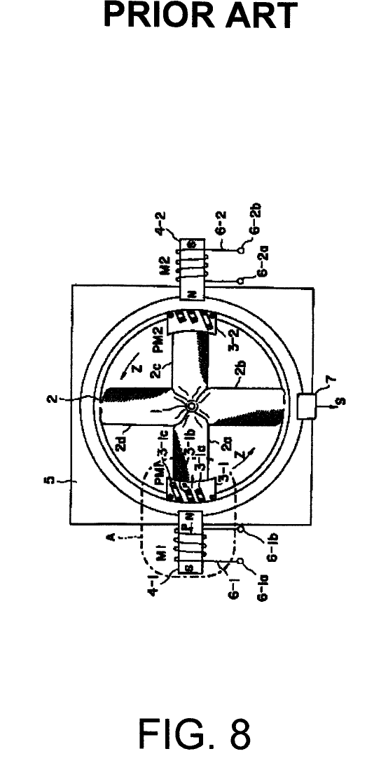

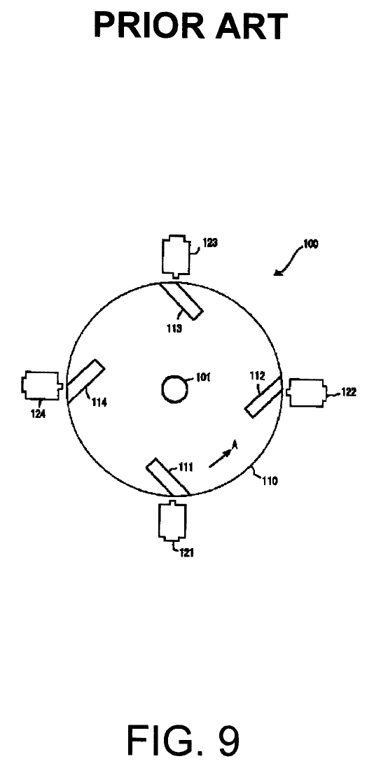

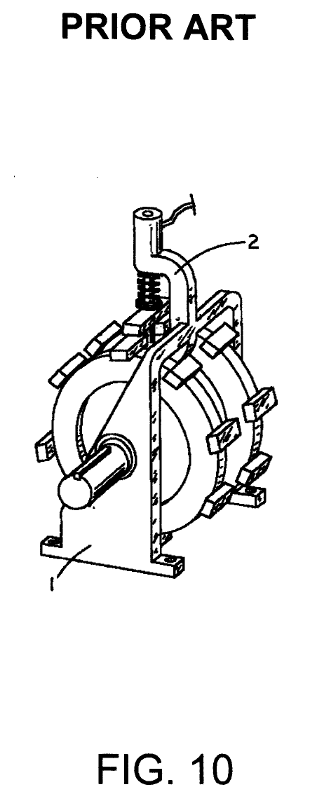

Moving now to FIG. 6, we see a schematic embodiment of this invention where the output from said invention can be configured and coupled with a plurality of beveled gears 50 to power a number of generators or machines 75 requiring such force. This rotary invention with its plurality of rotors is designed to have no stator, doesn't bring into itself or receive external sources of electrical or other energy.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A machine for operation of electrical generators and/or other mechanical machines (The Cleveland Engine) comprising:
A number of parallel, rotatable shafts thereon affixed a number of equally spaced, perpendicular extensions comprising permanent magnets attached to said extensions and arranged so as to allow repelling magnetic interaction; and where said shafts also comprise a means of maintaining required spacing and rotational timing to allow said magnets to interact a number of times per rotation causing perpetual movement.
A magnetic motor according to claim 1 wherein said motor comprises a number of rotors and no stator.
A magnetic motor according to claim 1 wherein said rotatable shafts comprise a number of gears of differing lengths.
A magnetic motor according to claim 1 wherein said gears maintain rotational timing.
A magnetic motor according to claim 1 wherein said rotatable shafts comprise a number of equally spaced, perpendicular extensions.
A magnetic motor according to claim 1 wherein said extensions comprise a number of permanent magnets affixed thereon to.
A magnetic motor according to claim 1 where said rotatable shafts are supported in a manner such as to allow gear and magnet interaction between shafts when interaction is intended.
A magnetic motor according to claim 1 wherein shaft(s) can rotate while sliding or at rest in differing positions.
